(19) United States
(12) Patent Application Publication
(10) Pub. No.: US 2003/0219085 A1
(43) Pub. Date: Nov. 27, 2003

(54) Self-initializing decision feedback equalizer with automatic gain control

(76) Inventors: Thomas J. Endres, Seattle, WA (US); Christoper D. Long, Maple Valley, WA (US); Jeffery K. Cunningham, Seattle, WA (US); Gary A. Ray, Issaquah, WA (US)

Correspondence Address: JOHN S. PRATT, ESQ, KILPATRICK STOCKTON, LLP, 1100 PEACHTREE STREET, SUITE 2800, ATLANTA, GA, 30309, US

(21) Appl. No.: 10/322,299

(22) Filed: Dec. 17, 2002

Related U.S. Application Data
(60) Provisional application No. 60/341,931, filed on Dec. 18, 2001.

(51) Int. Cl. H04B 1/10

(52) U.S. Cl. 375/350

(57) ABSTRACT

The present invention uses a feedback equalizer architecture with feedback samples comprised of weighted contributions of scaled soft and inversely-scaled hard decision samples, and adapts forward and feedback filters using weighted contributions of update error terms, such as Constant Modulus Algorithm (CMA) and Least Mean Squares (LMS) error terms. Combining weights are selected on a symbol-by-symbol basis by a novel measure of current sample quality. Adaptation methods of the sample quality measure are discussed. Furthermore, the present invention contains an automatic gain control circuit whose gain is adjusted at every symbol instance by a stochastic gradient descent update rule, minimizing novel cost criteria, to provide scaling factors for the hard and soft decisions.

### RELATED APPLICATION

This document relies on the priority of U.S. Ser. No. 60/341931 filed Dec. 18, 2001 and entitled “Self-Initializing Decision Feedback Equalizer With Automatic Gain Control” which is incorporated herein by this reference

### BACKGROUND

The present invention relates to Decision Feedback Equalization (DFE) techniques to compensate for distortions introduced in digital communications systems using modulation techniques such as Quadrature Amplitude Modulation (QAM) or Pulse Amplitude Modulation (PAM).

In many digital communication systems, a source generates digital information, such as data, audio, or video, that is to be transmitted to multiple receivers. The digital information bits are divided into blocks that define a discrete alphabet of symbols. These symbols are used to modulate a radio frequency (RF) carrier's frequency, amplitude and/or phase. For example, a quadrature oscillator can be used to modulate the symbols onto the amplitude and phase of the RF carrier, and the signaling is referred to as Quadrature Amplitude Modulation (QAM). The time interval between symbols is referred to as the symbol or baud interval, and the inverse of this interval is referred to as the symbol or baud rate.

Most modern digital communication systems use a symbol rate that sends thousands or millions of symbols per second, over propagation media including satellite links through the earth's atmosphere, terrestrial links from towers to fixed or mobile land-based receivers, or wired links using ancient twisted-pair copper connections or more sophisticated fiber optic connections. Such media are dispersive, causing reflections and multiple path delays arriving coincidently at the receiver. Such behavior is known as multipath, and causes symbols to smear across multiple symbol boundaries, which is referred to as inter-symbol interference (ISI). Moreover, mismatches in transmitter and receiver filtering induce ISI. Noise is added to the received signal from transmitter and receiver component imperfections, and from sources through the propagation path. At the receiver, an equalizer is used to mitigate the effects of ISI and noise induced in the entire channel, including transmitter, propagation medium, and front-end receiver processing. Since the exact channel characteristics are not known apriori at the receiver, the equalizer is usually implemented with adaptive methods.

A common type of equalizer uses adaptive filters, and the adjustment of filter coefficients can be done in a variety of ways. Trained equalization methods rely on the embedding of a pre-determined sequence in the transmitted data, referred to as a training or reference sequence. The receiver stores or generates a replica of the training sequence, and to the extent that the received sequence differs from the training sequence, an error measure is derived to adjust equalizer coefficients. Usually, equalizer coefficient convergence relies on multiple transmissions of the training sequence, and the channel characteristics are also time varying. Hence, periodic re-training is necessary.

A common method of trained coefficient adaptation uses the Least Mean Squares (LMS) algorithm, which minimizes a Mean Squared Error (MSE) cost function with a stochastic gradient descent update rule. The LMS algorithm was originally proposed by Widrow to distinguish a fetus' heartbeat from a mother's heartbeat, and is further and concisely described in a paper entitled “The complex LMS algorithm,” by Widrow, McCool, and Ball, in The Proceedings of the IEEE, vol. 63, no. 4, pp. 719-720, April 1975.

Unfortunately, the training sequence needed for LMS takes up valuable bandwidth that could be used for data transmissions. Hence, methods that do not rely on a reference signal, or derive a reference signal from the data itself, are desirable. Such methods are referred to as blind equalization methods. A common blind equalization method replaces the reference signal in the LMS algorithm with the receiver's best guess at the data, and is therefore referred to as Decision Directed LMS (DD-LMS), as proposed in a paper entitled “Techniques for adaptive equalization of digital communication systems,” by R. W. Lucky, in the Bell Systems Technical Journal, vol. 45, no. 2, pp. 255-286, Febuary 1966. Unfortunately, DD-LMS needs a reasonably low percentage of incorrect decisions to prevent algorithm divergence, and is therefore impractical from a cold-start initialization. Other blind algorithms are usually used from a cold-start.

The Constant Modulus Algorithm (CMA) was originally proposed by Godard to decouple equalization from carrier tracking for QAM signals, and further developed by Treichler and Agee for constant envelope Frequency Modulated (FM) signals. Godard's work can be found in a paper entitled “Self-recovering equalization and carrier tracking in two-dimensional data communication systems,” by. D. N. Godard, in IEEE Transactions on Communications, vol. 28, no. 11, pp. 1867-1875, October 1980. Treichler and Agee's later work can be found in a paper entitled “A new approach to multipath correction of constant modulus signals,” by J. R. Treichler, and B. G. Agee, in IEEE Transactions on Acoustics, Speech, and Signal Processing, vol. ASSP-31, no. 2, pp. 459-472, April 1983. CMA has rapidly become the most popular blind equalization algorithm in practice, and is well-studied in the archival literature, due to its robustness to realistic signaling environments and LMS-like computational complexity and asymptotic performance. Instead of minimizing a MSE cost function, CMA minimizes a quartic Constant Modulus (CM) cost function that penalizes dispersion at the equalizer output.

Though both LMS and CMA were originally introduced using a linear transversal, or finite impulse response (FIR) equalizer structure, a Decision Feedback Equalizer (DFE) is generally believed to provide superior ISI cancellation with less noise gain than an FIR equalizer structure. Austin was perhaps the first to propose a DFE, in a report entitled “Decision feedback equalization for digital communication over dispersive channels,” MIT Lincoln Labs Technical Report No. 437, Lexington, Mass., August 1967. A DFE acts to additively cancel ISI by subtracting filtered decisions (or best guesses, also known as hard decisions) from the received waveform. The feedback structure embeds a FIR filter in a feedback loop, fed by symbol estimates, and therefore has infinite impulse response (IIR). Like DD-LMS, the DFE architecture requires a low percentage of incorrect decisions to prevent algorithm divergence and error propagation, a phenomenon whereby an incorrect decision causes more incorrect decisions due to the feedback loop of the DFE. Therefore, a DFE requires alternative methods from a cold-start. A summary of such techniques is presented in a chapter entitled “Current approaches to blind decision feedback equalization,” by R. A. Casas et al., in the textbook, “Signal processing advances in wireless and mobile communications: trends in channel estimation and equalization,” edited by G. Giannakis, et al., Prentice Hall, Upper Saddle River, N.J., 2000.

The present invention uses a feedback equalizer architecture with feedback samples comprised of weighted contributions of scaled soft and inversely-scaled hard decision samples, and adapts forward and feedback filters using weighted contributions of update error terms, such as Constant Modulus Algorithm (CMA) and Least Mean Squares (LMS) error terms. Combining weights are selected on a symbol-by-symbol basis by a novel measure of current sample quality. Furthermore, the present invention contains an automatic gain control circuit whose gain is adjusted at every symbol instance by a stochastic gradient descent update rule, minimizing novel cost criteria, to provide scaling factors for the hard and soft decisions. All books, patents, documents and other works cited in this document are incorporated herein by reference.

### SUMMARY

In accordance with various aspects of the present invention, a Decision Feedback Equalizer (DFE) uses input samples to the feedback filter that are weighted contributions of soft and hard decision samples, and adapts forward and feedback filters using weighted contributions of update error terms, such as Constant Modulus Algorithm (CMA) and Least Mean Squares (LMS) error terms, and selects weighting factors on a sample-by-sample basis by a measure of current sample quality. Furthermore, the present invention contains an automatic gain control circuit whose gain is adjusted at every sample instance by a stochastic gradient descent update rule, decoupling amplitude compensation from inter-symbol interference (ISI) mitigation.

### BRIEF DESCRIPTION OF DRAWINGS

Other aspects, features, and advantages of the present invention will become more fully apparent from the following detailed description, the appended claims, and the accompanying drawings in which:

FIG. 1 shows a typical prior art communication system that may be employed for transmission of digital signals;

FIG. 2 shows an exemplary embodiment of the present invention, showing a self-initializing decision feedback equalizer operating at precise baseband;

FIG. 3 shows a 16-QAM constellation and single decision region, illustrating measures used to derived combing weights λ(n) and 1−λ(n) for the present invention;

FIG. 4 depicts a circuit used to calculate combining weight λ(n) and automatic gain control signal α(n) in accordance with the preferred embodiment of the present invention;

FIG. 4a shows the combining weight λ(n) trajectory from a computer simulation of the preferred embodiment of the present invention;

FIG. 4b shows the automatic gain control signal α(n) and error term ξ(n) from a computer simulation of the preferred embodiment of the present invention;

FIG. 4c shows the in-phase component of the equalizer output from a computer simulation of the preferred embodiment of the present invention;

FIG. 5 shows an alternative embodiment of the present invention, with equalizer forward and feedback filters operating on passband samples; and

FIG. 6 shows an alternative embodiment of the present invention, with equalizer forward filter operating on passband samples, and equalizer feedback filter operating on baseband samples.

### DETAILED DESCRIPTION

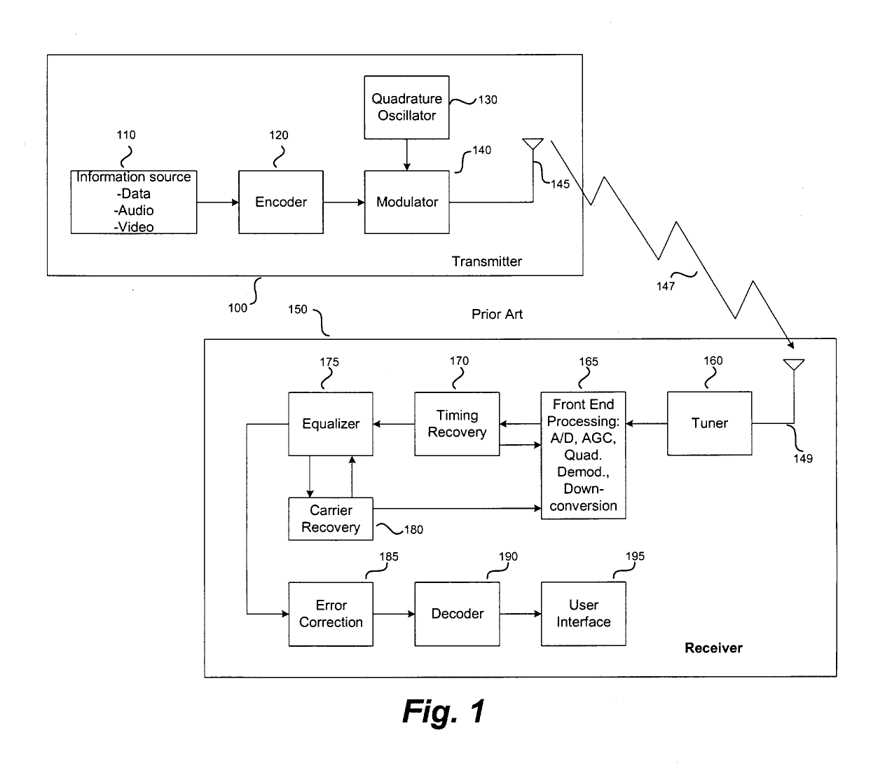

FIG. 1 depicts a typical prior art digital communication system. Transmitter station 100 is coupled to receiver 150 by propagation medium 147. The propagation medium could be a cable, telephone twisted-pair wire, satellite link, terrestrial link, or fiber optic connection, for example. Transmitter station 100 includes an information source 110, that contains the content such as data, audio, or video, which is to be communicated to the receiver 150. The information source 110 is coupled to encoder 120, which formats the information in a manner suitable for digital communication, typically in accordance with a given standard or protocol. The encoder 120 is coupled to modulator 140, which is also coupled to a quadrature oscillator 130. The modulator 140 uses the signal from the quadrature oscillator 130 to modulate the encoded information provided by encoder 120 onto a suitable Radio Frequency (RF) carrier frequency in amplitude and phase. The modulated signal from modulator 140 is coupled to transmit antenna 145 for transmission into propagation medium 147.

The receiver 150 receives the RF signal from propagation medium 147 via receiver antenna 149. Receiver antenna 149 is coupled to tuner 160. Tuner 160 is set to receive the RF signal in the desired frequency range, while rejecting signals in nearby or adjacent frequency ranges. Tuner 160 may provide automatic gain control at the RF frequency and also downconvert the received signal to an intermediate frequency (IF) before passing the signal to the Front End Processing block 165. Front End Processing block 165 samples the signal with an analog-to-digital converter and contains an automatic gain control circuit that scales the signal to the proper dynamic range in accordance with the analog-to-digital converter. Front End Processing block 165 may further include a digital downconversion in frequency, and performs a quadrature demodulation to split the signal into in-phase (I) and quadrature-phase (Q) samples. Front End Processing block 165 is coupled to Timing Recovery module 170 that determines a correct sampling phase. Timing Recovery module 170 may adjust the sampling phase by interpolating the data samples, or adjusting the phase and sampling frequency of the analog-to-digital converter in Front End Processing block 165. Timing Recovery module 170 is coupled to Equalizer 175, which is used to mitigate the distortions, such as inter-symbol interference and noise, that are introduced by the propagation medium 147, transmitter 100, receiver Tuner 160, receiver Front End Processing block 165, and receiver Timing Recovery module 170. Equalizer 175 is coupled to Carrier Recovery module 180, which detects residual offset in frequency and phase. The detected carrier offset in Carrier Recovery module may be supplied back to the Equalizer 175 for translation of equalized samples to precise baseband, or used to adjust the downconversion process in Front End Processing block 165, or both. The output of Equalizer 175 is coupled to Error Correction module 185, which detects and corrects bit errors in the recovered bit stream. The Error Correction module 185 is coupled to Decoder 190, which decodes the bit stream in accordance with the standard or protocol used in the Encoder 120 of Transmitter 100. The decoded bits from Decoder 190 represent the recovered information source, consisting of data, audio, or video, and are supplied to a user interface 195. The present invention is embodied in the Equalizer 175 portion of the communication system.

Baseband/Baseband Equalization

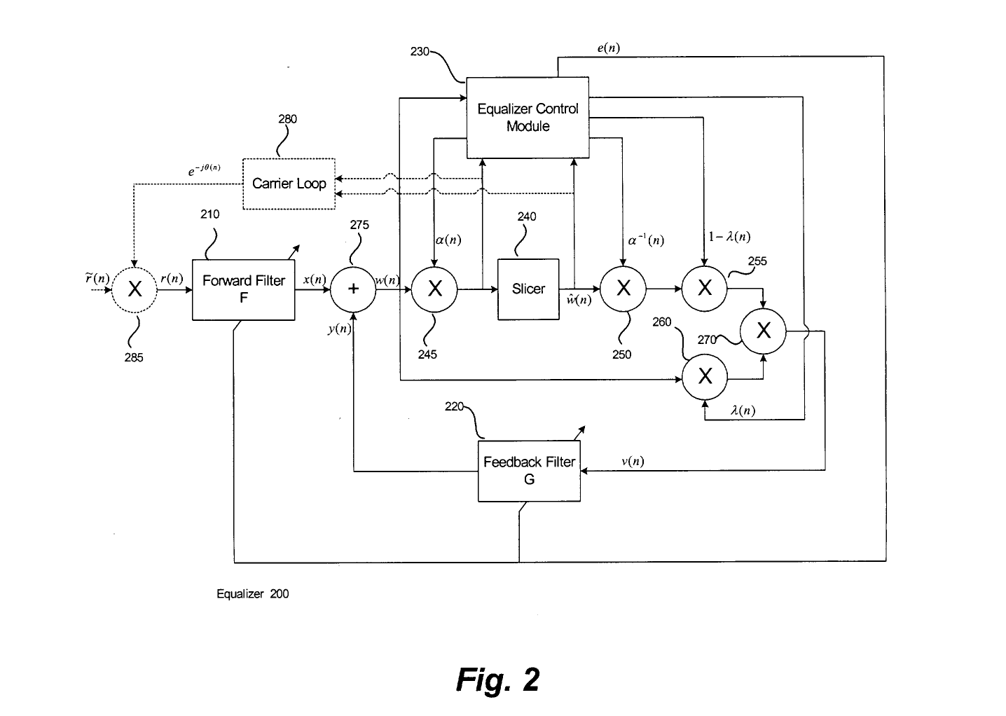

FIG. 2 shows an exemplary embodiment of the present invention. An Equalizer 200 receives complex data \tilde{r}(n) that is input to mixer 285. The mixer 285 also receives a signal from carrier recovery loop 280, e^{-jθ(n)}, that is an estimate of the conjugate of the carrier offset. Methods of carrier recovery are well known to one skilled in the art, and may be found, for example, in chapter 16 of the text “Digital Communication” by E. A. Lee and D. G. Messerschmitt, Kluwer Academic Publishers, 1994, which is incorporated herein by reference. The carrier recovery loop 280 and mixer 285 are shown as dashed lines, to represent that translation to precise baseband is done prior to equalization, and may be done anywhere prior to equalization in the signal processing chain. For example, some systems embed pilot tones or pulses to aid synchronization, allowing translation to precise baseband in the receiver front end, prior to equalization. In this exemplary embodiment of the invention, the equalizer 200 operates on samples that have been translated to precise baseband.

The output of mixer 285 is a received signal, r(n), that is at precise baseband, and is input to forward filter 210. Forward filter 210 may operate at the baud rate or faster, in which case the equalizer is said to be fractionally-spaced, and exploits temporal diversity. Also, the forward filter 210 may receive multiple inputs, as from multiple antennae, to exploit spatial diversity. Temporal or spatial diversity uses a multi-channel forward filter. For simplicity, however, a single forward filter 210 is shown, and extension to a multi-channel model is understood by one skilled in the art.

Filtering

Forward filter 210 is a finite impulse response (FIR) filter, computing its output according to the convolution sum

x(n)=f₀(n)r(n)+f₁(n)r(n−1)+f₂(n)r(n−2)+ . . . +f_{L}_{_{f}}₋₁(n)r(n−L_{f}+1)

where r(n) is the sample sequence input to forward filter 210, x(n) is the output sample sequence of forward filter 210, fᵢ are the forward filter coefficients (or parameters,) and L_{f} is the number of forward filter coefficients. Note that the forward filter coefficients are also shown with time index n to indicate that the forward filter 210 is adaptive.

The feedback filter 220 is not multi-channel, and is a FIR filter that calculates its output according to the convolution sum

y(n)=g₀(n)v(n)+g₁(n)v(n−1)+g₂(n)v(n−2)+ . . . +g_{L}_{_{g}}₋₁(n)v(n−L_{g}+1)

where v(n) is the sample sequence input to feedback filter 220, y(n) is the output sample sequence of feedback filter 220, gᵢ are the feedback filter coefficients (or parameters,) and L_{g} is the number of feedback filter coefficients. Note that the feedback filter coefficients are also shown with time index n to indicate that the feedback filter 220 is adaptive. Though the feedback filter 220 is a FIR filter, it is embedded in a feedback loop, so that the equalizer has an overall impulse response that is infinite.

Adder 275 combines the outputs of forward filter 210 and feedback filter 220, x(n) and y(n), respectively, to form sample sequence w(n). Sample sequence w(n) is referred to as soft decisions. The soft decisions, w(n), are scaled in multiplier 245 by real-valued, strictly positive gain α(n), an automatic gain control signal that is computed in the equalizer control module 230. The scaled soft decisions from multiplier 245 are input to slicer 240. Slicer 240 is a nearest-element decision device that outputs a hard decision, ŵ(n), corresponding to the source alphabet member with closest Euclidean distance to its input sample. The hard decisions, ŵ(n), from slicer 240 are scaled in multiplier 250 by real scalar α⁻¹(n), the inverse of the automatic gain control signal that was used to scale the soft decisions in multiplier 245.

In addition to automatic gain control signals α(n) and α⁻¹(n), equalizer control module 230 also provides real combining weights λ(n) and 1−λ(n) that are used to compute the feedback sample used in the feedback filter 220. For example, the scaled hard decision from multiplier 250 is scaled again in multiplier 255 by combining weight 1−λ(n). Simultaneously, the soft decision, w(n), from adder 275 is scaled in multiplier 260 by combining weight λ(n). The outputs of multipliers 255 and 260 are combined in adder 270 to produce sample v(n), the input to feedback filter 220. Hence, the feedback regressor (or input) data v(n) is expressed as

v(n)=λ(n)·w(n)+(1−λ(n))·(α⁻¹(n)ŵ(n))

Coefficient Adaptation

Adaptation of the forward filter 210 coefficients and feedback filter 220 coefficients uses a stochastic gradient descent update rule:

fᵢ(n+1)=fᵢ(n)−μ_{f}φ*(n)e(n)

gᵢ(n+1)=gᵢ(n)−μ_{g}φ*(n)e(n)

where (·)^{*} represents complex conjugation, and μ_{f} and μ_{g} are small, positive stepsizes governing algorithm convergence rate, tracking capabilities and stochastic jitter. Using simplified updates, the data used in the adaptation equations are set to φ(n)=r(n) and φ(n)=v(n). The baseband error term e(n)that updates the forward filter 210 and feedback filter 220 at each baud instance is selected using the combining weights λ(n) and 1−λ(n),

e(n)=λ(n)·e₁(n)+(1−λ(n))·e₂(n).

The preferred embodiment of the present invention uses a Constant Modulus Algorithm (CMA) error term of order p=2 (as described by Godard in “Self recovering equalization and carrier tracking in two-dimensional data communication systems”) for e₁(n) and a Decision-Directed LMS (DD-LMS) error term for e₂(n). For example, CMA ad DD-LMS error terms may be calculated according to

e_{cma}=w(n)·(|w(n)|²−γ)

e_{dd-lms}=α(n)·w(n)−ŵ(n)

where γ is a real scalar referred to as the CM dispersion constant or Godard radius, and is usually calculated as γ=E{|s(n)|⁴}/E{|s(n)|²} for source sequence s(n), with E{·} denoting statistical expectation and |·| denoting absolute value, or magnitude. (These error terms are said to be baseband, since they are derived from samples at precise baseband.) Other choices of error terms may include CMA error terms of order other than p=2; those derived from the Bussgang class of cost functions, as described in chapter 2 of “Blind Deconvolution,” Prentice Hall, written by S. Bellini, edited by S. Haykin, 1994; single-axis error terms which use real-part extraction, as described in a paper by A. Shah et al, entitled “Global convergence of a single-axis constant modulus algorithm,” Proceedings of the IEEE statistical signal and array processing workshop, Pocono Manor, Pa., August, 2000; or error terms derived from other blind or non-blind criteria.

Setting φ(n)=r(n) and φ(n)=v(n) in the above equations used to adapt forward filter 210 and feedback filter 220 coefficients is referred to as “simplified updates,” since the step known as regressor filtering is omitted. True cost function minimization requires an extra stage of filtering for the regressor data of the forward filter 210 and the feedback filter 220 in the adaptation process, using the current equalizer coefficients. Such regressor filtering is typically omitted in practice due to implementation burden. Regressor filtering is described in Chapter 5 of “Theory and design of adaptive filters” by J. R. Treichler, C. R. Johnson, Jr., and M. G. Larimore, Prentice Hall, 2001. One skilled in the art would recognize how to modify the regressor data used in the adaptation equations above to incorporate the extra stage of regressor filtering.

Equalizer Control (Combining Weights and AGC)

Combining Weights

Equalizer control module 230 computes the automatic gain control signals α(n) and α⁻¹(n), the combining weights λ(n) and 1−λ(n), and the adaptive error term e(n), at each baud instance. Inputs to the equalizer control module 230 include the input and output signals of slicer 240, α(n)·w(n) and ŵ(n), respectively, and the soft decision, w(n), output from adder 275.

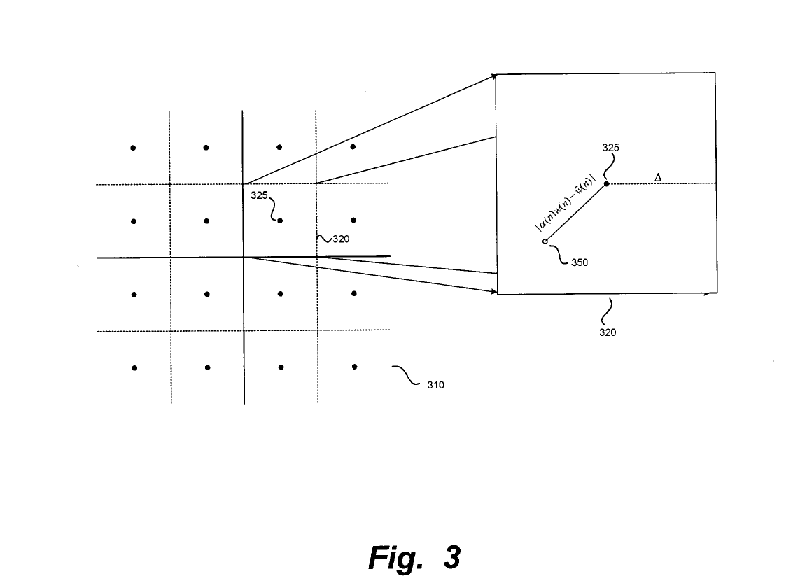

The combining weights are chosen at each baud instance by comparing the distance of the scaled soft decision, α(n)·w(n), to its nearest element in the source constellation, and normalizing by the size of the decision region. This idea is illustrated in FIG. 3, using a 16-QAM alphabet.

The left-hand-side of FIG. 3 shows a 16-QAM constellation 310, and the right-hand-side is an exploded view of a single decision region 320 for the constellation point 325. The width of the decision region is 2Δ, and the distance of the scaled soft decision 350 to the constellation point 325 is therefore |α(n)·w(n)−ŵ(n)|. Excluding outermost constellation points that have open decision regions, the ratio \tilde{λ}(n)=|α(n)·w(n)−ŵ(n)|/\sqrt{2}Δ does not exceed unity. For those outermost constellation points, if \tilde{λ}(n) exceeds unity, it is set to unity. Hence, on an instantaneous basis, \tilde{λ}(n) is bounded between zero and one, and provides an instantaneous measure of signal integrity: when the scaled soft decision 350 is far from the hard decision (constellation point) 325, \tilde{λ}(n) is close to unity; when the scaled soft decision 350 is close to the constellation point 325, \tilde{λ}(n) is close to zero. Using \tilde{λ}(n) and 1−\tilde{λ}(n) as the instantaneous combining weights (instead of λ(n) and 1−λ(n),) when the scaled soft decision is far from the hard decision, \tilde{λ}(n)≈1 and the signal integrity is deemed low, so that feedback sample v(n) is comprised mostly of a soft decision and the update error term is comprised mostly of the CMA error term. Conversely, when the scaled soft decision is close to the hard decision, \tilde{λ}(n)≈0 and the signal integrity is deemed high, so that the feedback sample v(n) is comprised mostly of a hard decision and the update error term is comprised mostly of the DD-LMS error term. As the equalizer coefficients adapt and the constellation eye is opened, the combining weight \tilde{λ}(n) adapts from one toward zero. Hence, the DFE is self-initializing, senses changes in the propagation environment, for example due to impulsive noise, fades, or time-varying multipath, and automatically corrects for such situations by adapting the combining weight.

To add memory to the instantaneous combining weight \tilde{λ}(n), a leaky integrator is used, and the value of combining weight λ(n) is calculated as

λ(n)=(1−ρ_{λ})·λ(n−1)+ρ_{λ}·\tilde{λ}(n)

where ρ_{λ} is the leakage term and is chosen less than or equal to one and greater than or equal to zero.

In operation, the combining weight λ(n) at the start of adaptation is set to unity, so that soft decisions are used as feedback samples and the CMA error term is used for equalizer coefficient adaptation. The combining weight λ(n) may be forced to unity for a given number of samples after the start of equalizer coefficient adaptation before being adapted itself. Also, the combining weight λ(n) may be compared to two thresholds, T_{U} and T_{L}. If λ(n)>T_{U}, then λ(n) is set to one; if λ(n)<T_{L}, then λ(n) is set to zero.

Automatic Gain Control

The automatic gain control signal α(n) is a real, strictly positive scalar, that is calculated at each baud instance by stochastic gradient descent of a specified cost function, expressed as

$$α ( n ) = {ρ}_{α} α ( n - 1 ) - {μ}_{α} \frac{\partial J}{\partial α ( n - 1 )}$$

where ρ_{α} is a leakage factor used in practice to mitigate divergence due to finite-precision effects or quantization noise, and is chosen less than or equal to unity, but close to unity, J is the cost function to be minimized by choice of α(n), and μ_{α} is a real-valued, positive stepsize, chosen less than unity, and governs algorithm convergence rate, tracking capabilities, and stochastic jitter.

### MSE-Like Cost Function

The preferred embodiment of the present invention minimizes the cost function

J=E{(|α(n−1)·w(n−1)|^{q}−|ŵ(n−1)|^{q})²}

where q is a positive integer and is set to one for the preferred embodiment. This cost function penalizes the squared difference in magnitudes between the slicer input and output, and is analogous to a mean squared error (MSE) cost function. The partial derivative calculation, assuming correct decisions and neglecting the expectation, for q=1, results in

$$\begin{matrix}\frac{\partial J}{\partial α ( n - 1 )} = 2 \cdot [ \vert α ( n - 1 ) \cdot w ( n - 1 ) \vert - \\ \vert \hat{w} ( n - 1 ) \vert ] \cdot \vert w ( n - 1 ) \vert \cdot sign ( α ( n - 1 ) )\end{matrix}$$

Note that the factor of 2 can be absorbed into the stepsize μ_{α}, and that sign(α(n−1)) is always one since the automatic gain control signal is strictly positive by definition. Defining \tilde{ξ}(n−1)≡∂J/∂α(n−1) as the automatic gain control error term, the partial derivative is expressed as

\tilde{ξ}(n−1)=[α(n−1)·|w(n−1)|−|ŵ(n−1)|]·|w(n−1)

Since the automatic gain control signal, α(n), is applied to multiplier 245 in FIG. 2 at the current sample instance n, but also requires the use of the output of the multiplier 245 in its calculation, a delay of one sample has been inserted in the calculation of \tilde{ξ}(n−1) and the cost function to keep the system causal.

The error term \tilde{ξ}(n−1) can be applied directly to the stochastic gradient descent update rule to calculate the automatic gain control signal α(n). Alternatively, a leaky integrator can be applied to the error term before it is used to adapt the automatic gain control signal, α(n), to induce memory in and reduce the variance of the error signal. For example, the error term used in the stochastic gradient update can be calculated as

ξ(n−1)=(1−ρ_{agc})·ξ(n−2)+ρ_{agc}·\tilde{ξ}(n−1)

with automatic gain control signal calculated as

α(n)=ρ_{α}α(n−1)−μ_{αξ(}n−1)

where ρ_{agc} is chosen greater than or equal to zero, but less than or equal to one, and is a leakage factor. Selecting ρ_{agc}=1 represents no leakage and induces no memory in the error term. In this case, the error term relies purely on the unity-delayed samples and ξ(n−1)=\tilde{ξ}(n−1).

An alternative embodiment of the present invention uses arbitrary positive integer q in the MSE-like cost function. In this case, the error term found by partial differentiation reduces to

\tilde{ξ}(n−1)=[|α(n−1)·w(n−1)|^{q}−|ŵ(n−1)|^{q}]·|α(n−1)·w(n−1)|^{q-1}·|w(n−1)|

where a factor of 2 has been absorbed into the stepsize, and we have used the fact that sign(α(n−1))=1 since the automatic gain control signal is strictly positive. Leakage to this error term can be applied before using it in the stochastic gradient descent update of α(n), as described for the q=1 case.

An alternative embodiment of the MSE-like cost function uses normalized samples, by the magnitude of the hard decision, to weight the error signals equally across different constellation points. In this case, the cost function is written as

$$J = E \{ {( \frac{{\vert α ( n - 1 ) \cdot w ( n - 1 ) \vert}^{q} - {\vert \hat{w} ( n - 1 ) \vert}^{q}}{\vert \hat{w} ( n - 1 ) \vert} )}^{2} \}$$

Assuming that the decisions are correct, the error terms \tilde{ξ}(n−1) derived above without the normalization factor can be used, and the normalization factor absorbed into the stepsize. In this case, the stepsize becomes μ(n−1)=μ/|ŵ(n−1)|², and is time-varying, depending on the current data sample. In practice, the time-varying stepsize can be calculated with a look-up-table to avoid division.

### CM-Like Cost Function

An alternative embodiment of the present invention uses a cost function that is analogous to a Constant Modulus (CM) cost function, defined as

J=E{(|α(n−1)·w(n−1)|^{q}−γ)²}

This cost function has the advantage that it does not rely on correct hard decisions. Letting q=2, taking the partial derivative and neglecting the expectation (as in the previous case for the MSE-like cost function)

$$\frac{\partial J}{\partial α ( n - 1 )} = 4 \cdot \vert α ( n - 1 ) w ( n - 1 ) \vert \cdot \vert w ( n - 1 ) \vert \cdot ( {\vert α ( n - 1 ) \cdot w ( n - 1 ) \vert}^{2} - γ ) \cdot sign ( α ( n - 1 ) )$$

Recognizing that |α(n−1)w(n−1)|=α(n−1)·|w(n−1)|·sign(α(n−1)), and absorbing the factor of 4 into the stepsize, the error term reduces to

\tilde{ξ}(n−1)=α(n−1)·|w(n−1)|²·(|α(n−1)·w(n−1)|²−γ)

This derivation does not depend on the fact that the automatic gain control signal is strictly positive, unlike the previous cost function, since the sign operators square to unity.

The constant γ is calculated analogously to the Godard radius used in adaptation of the equalizer coefficients. Leakage to this error term can be applied in the same way as done to the prior error terms used to update the automatic gain control signal, α(n), or it can be applied directly to the stochastic gradient update rule.

An alternative CM-like cost function uses q=1. The error term from the partial derivative is found as

\tilde{ξ}(n−1)=|w(n−1)|·(|α(n−1)·w(n−1)|−γ)

where a factor of 2 has been absorbed into the stepsize, and we have used the fact that sign(α(n−1))=1 since the automatic gain control signal is strictly positive. In this case with q=1, the Godard radius is calculated as γ=E{|s|²}/E{|s|}.

Another embodiment of the present invention combines these two automatic gain control error terms, one MSE-like, and one CM-like, using the combining weights λ(n) and 1−λ(n), as previously described.

An alternative embodiment of the present invention adds a penalty term to one of the cost functions already described. This penalty term is used to restore the AGC gain value to a nominal, steady-state value, and reduce undesired interaction between equalizer and feedback AGC adaptation. For example, the modified cost function is expressed as

J+E{β·(α(n−1)−Γ)²}

where β is a small, non-negative weighting factor for the penalty term, and Γ is a target threshold, for example, unity. The new update equation for the AGC gain value is found by partial differentiation of the modified cost function. Neglecting the expectation and absorbing a factor of two into β, the update equation is found as

α(n)=ρ_{α}α(n−1)−μ_{α}ξ(n−1)−μ_{α}·β·(α(n−1)−Γ)

In practice, the product μ_{α}·β can be replaced with β alone, and a multiplication avoided.

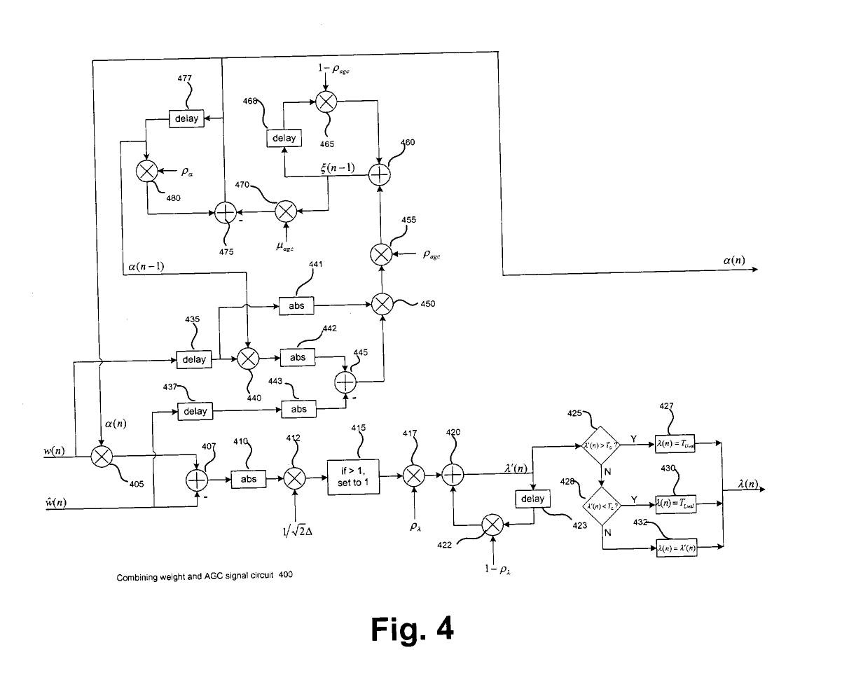

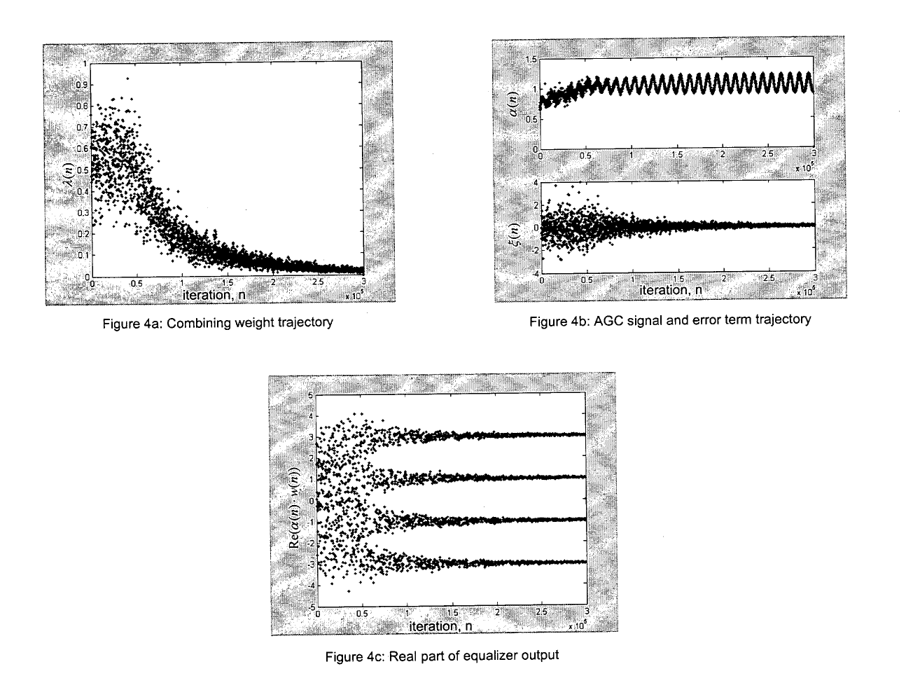

A circuit contained in the equalizer control module (230 in FIG. 2) used to calculate the combining weight λ(n) and automatic gain control signal α(n) in accordance with the preferred embodiment of the present invention is shown in FIG. 4. The circuit receives soft decision sample w(n) and hard decision sample ŵ(n). The lower leg of the circuit calculates combining weight λ(n), and the upper leg of the circuit calculates automatic gain control signal α(n).

To calculate the combining weight λ(n), the current soft decision w(n) is first scaled by the current value of the automatic gain control signal α(n) in multiplier 405, and the current hard decision ŵ(n) is subtracted from the result in adder 407. The absolute value of this difference is calculated in 410, and the result is scaled by 1/\sqrt{2}Δ in multiplier 412. The result is held to unity if it is greater than unity in comparator 415, accounting for open decision regions of the outermost points of the source constellation. Leakage is applied to the result by multiplication with ρ_{λ} in multiplier 417. Adder 420 adds the result from multiplier 417 with the result from multiplier 422 to form candidate combining weight λ′(n). Multiplier 422 multiplies the internal state of the integrator, λ′(n−1), held from delay element 423, with leakage value 1−ρ_{λ}. Candidate combining weight λ′(n) is compared to upper threshold T_{U} in comparator 425, and assignment block 427 sets λ(n)=T_{U} if the threshold condition λ′(n)>T_{U} in comparator 425 is satisfied. If the threshold comparison in comparator 425 is not satisfied, candidate combining weight λ′(n) is compared to lower threshold T_{L} in comparator 428, and assignmanet block 430 sets λ(n)=T_{L} if the threshold condition λ′(n)<T_{L} in comparator 428 is satisfied. If the threshold comparison in comparator 428 is not satisfied, the combining weight is set to λ(n)=λ′(n) in assignment block 432.

To calculate the automatic gain control signal α(n), previous soft decision sample w(n−1) from delay element 435 and previous hard decision sample ŵ(n−1) from delay element 437 are used. Multiplier 440 scales the previous soft decision sample w(n−1) with the previous automatic gain control signal, α(n−1), available from delay element 477. The absolute value of this result is calculated in 442, and the absolute value of the previous hard decision sample ŵ(n−1) is calculated in 443. The difference of the absolute values is calculated in adder 445, and this result is multiplied in multiplier 450 with the absolute value of the previous soft decision sample that is calculated in 441. The output of multiplier 450 is scaled by leakage factor ρ_{agc} in multiplier 455. Adder 460 combines the results of multiplier 455 and multiplier 465 to form error term ξ(n−1). Multiplier 465 multiplies the internal state of the integrator, ξ(n−2), held from delay element 468, with leakage value 1−ρ_{agc}. Error term ξ(n−1) is multiplied by stepsize μ_{α} in multiplier 470. Multiplier 480 multiplies the previous automatic gain control signal, α(n−1), available from delay element 477, with leakage factor ρ_{agc}. Adder 475 combines the results of multiplier 470 and multiplier 480 to form the current automatic gain control signal α(n).

FIGS. 4a, 4b, and 4c illustrate the outputs of the circuit in FIG. 4 and the equalizer output in operation from a computer simulation of the preferred embodiment of the present invention. The source signal is 16-QAM data passed through a closed-eye channel that has a sinusoidal AM hum component. There are 300,000 baud samples, with adaptation of equalizer coefficients, automatic gain control signals, and combining weights commencing at the start of the simulation. Leakage values are set to ρ_{α}=1, ρ_{agc}=0.55, and ρ_{λ}=0.55. Thresholds for the combining weight are set to T_{U}=1 and T_{L}=0, with the automatic gain control stepsize set to μ_{agc}=0.01.

FIG. 4a shows the trajectory of the combining weight λ(n), initialized to unity, and converging towards zero. The top subplot of FIG. 4b shows the trajectory of the automatic gain control signal α(n), which rattles at the beginning of the simulation due to a large number of incorrect decisions, then tracks well the sinusoidal AM hum as the eye is opened. The bottom subplot of FIG. 4b shows the trajectory of the automatic gain control signal error term, ξ(n), which converges towards zero. FIG. 4c shows the trajectory of the in-phase component of the equalizer output, converging to an open eye with all sinusoidal AM hum component removed.

In practice, rather than starting adaptation of all parameters simultaneously as done in the simulation results shown in FIGS. 4a, 4b, and 4c, adaptation of equalizer coefficients is started with λ(n) and α(n) held to unity. The combining weight λ(n) is then adapted by enabling the lower leg of the circuit in FIG. 4 after a fixed amount of time or after a performance measure such as MSE or bit-error-rate drops below a prescribed threshold. Once the eye is opened so correct decisions can be made, the automatic gain signal α(n) is adapted by enabling the upper leg of the circuit in FIG. 4. The combining weight λ(n) and automatic gain control signal α(n) are adaptive throughout the remainder of operation.

Passband/Passband Equalization

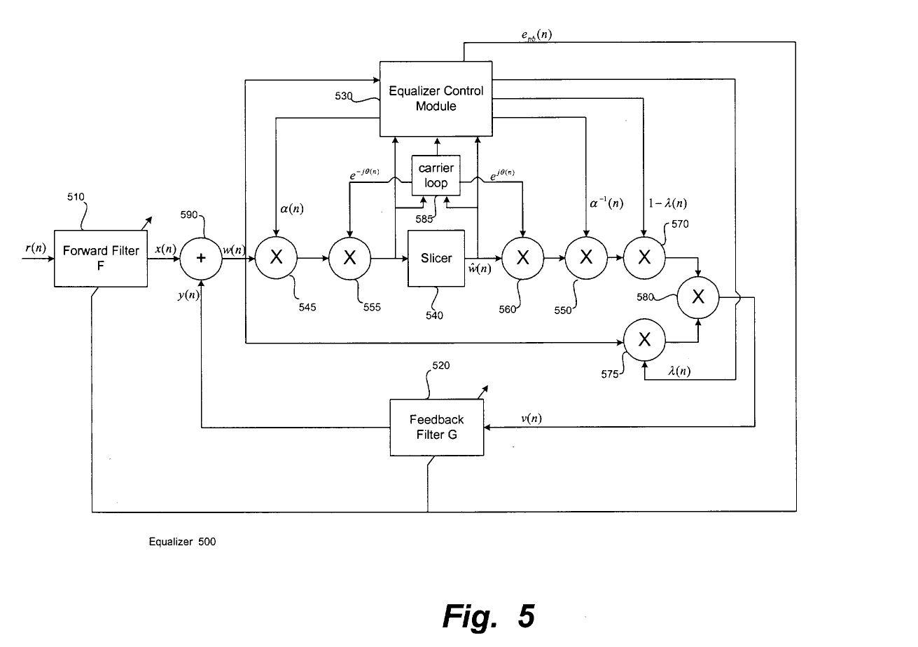

An alternative embodiment of the present invention is shown in FIG. 5, in which the equalizer 500 operates in the passband; that is, not at precise baseband. Equalizer 500 is similar to equalizer 200 in FIG. 2, so only the differences in equalizer 500 of FIG. 5 are described.

Forward filter 510 and feedback filter 520 produce data by convolution sums in an analogous manner to that described for the exemplary embodiment in FIG. 2, yielding passband signals x(n) and y(n), respectively. The outputs of forward filter 510 and feedback filter 520 are combined in adder 590, yielding the passband soft decision sample w(n). Multiplier 545 scales the passband soft decision sample by the real-valued automatic gain control signal α(n). The output of multiplier 545 is translated to precise baseband (or de-rotated) in multiplier 545 by multiplication with the conjugate of the carrier offset, e^{-jθ(n)}, provided by carrier recovery loop 585. The slicer 540 is a nearest-element decision device that outputs a hard decision, ŵ(n), corresponding to the source alphabet member with closest Euclidean distance to its input sample. The hard decision ŵ(n) is translated back to the passband in multiplier 560 by multiplication with the carrier offset e^{jθ(n)}, provided by the carrier recovery loop 585. Mutliplier 550 scales the rotated hard decision by the inverse of the automatic gain signal, producing the signal ŵ(n)·e^{jθ(n)}·α⁻¹(n) to multiplier 570. Multipliers 570 and 575 weight the rotated hard decision and soft decision, ŵ(n)·e^{jθ(n)}·α⁻¹(n) and w(n), by combining weights 1−λ(n) and λ(n), respectively, to be combined in adder 580, producing the feedback sample v(n).

The equalizer control module 530 receives passband soft decision w(n), scaled and de-rotated to baseband soft decision w(n)·α(n)·e^{-jθ(n)}, hard decision ŵ(n), and carrier offset e^{jθ(n)}. Calculation of combining weights λ(n) and 1−π(n) is analogous to the previous description, with w(n)·α(n)·e^{-jθ(n)} replacing α(n)·w(n) in calculating \tilde{λ}(n). This ensures that the combining weights are calculated with precise baseband data. The same substitution is used in calculating the automatic gain control signal α(n). However, equalizer adaptation must use an error term that is in the passband. The CMA error term uses signal w(n), which was at baseband as drawn in FIG. 2, but is now in the passband in equalizer 500 of FIG. 5. Hence, there is no change to the CMA error term equation: it defines a baseband error term for FIG. 2, and a passband error term for FIG. 5. However, the DD-LMS error term for equalizer 500 in FIG. 5 is modified slightly from that of equalizer 200 in FIG. 2, to

$${e}_{dd \text{-} lms}^{passband} = [ α ( n ) \cdot w ( n ) \cdot {ⅇ}^{- j θ ( n )} - \hat{w} ( n ) ] \cdot {ⅇ}^{j θ ( n )}$$

so that the difference is calculated from baseband samples, then re-rotated back to the passband. Since both forward filter 510 and feedback filter 520 operate in the passband, they are updated with passband error terms.

Also note that the order of multipliers 545 and 555, and the order of multipliers 550 and 560, can be swapped; scaling by automatic gain control signals α(n) and α⁻¹(n) can be done in the passband or precise baseband, since the automatic gain control signals are real-valued.

Passband/Baseband Equalization

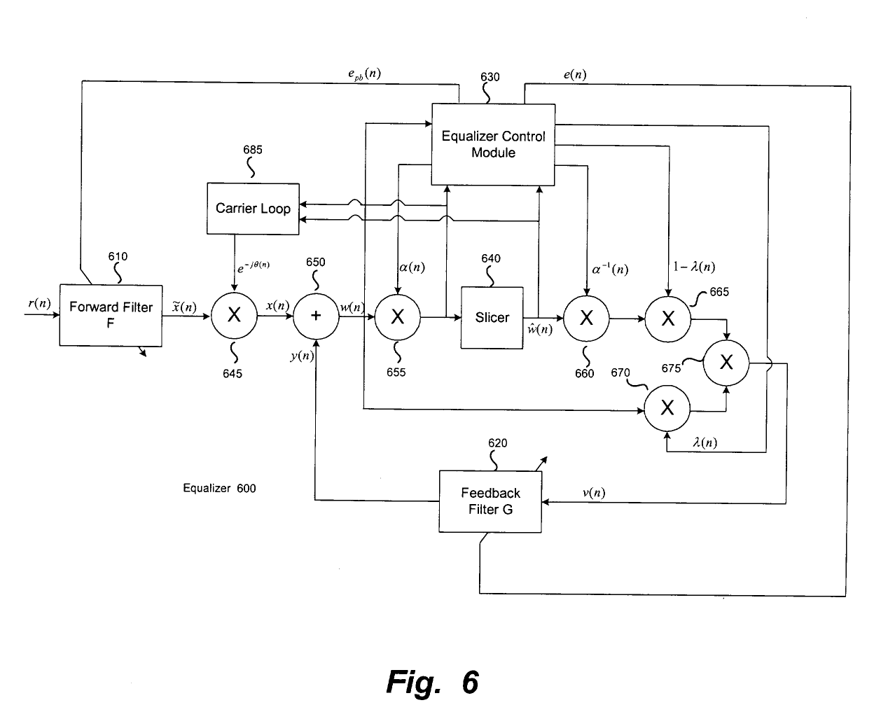

FIG. 6 shows equalizer 600, an alternative embodiment of the present invention, in which the forward filter 610 operates on passband data, while the feedback filter 650, and all processing after multiplier 645, operate at precise baseband. Forward filter 610 operates on received passband data r(n) and calculates output x_{pb}(n) via the convolution sum discussed for the filtering process of equalizer 200 in FIG. 2. Multiplier 645 translates the output of forward filter 610 to precise baseband by multiplication with the conjugate of the carrier offset estimate, e^{-jθ(n)}, provided by carrier recovery loop 685. The remainder of the equalizer 600 operates analogously to the equalizer 200 in FIG. 2, except that the equalizer control module 630 receives also the carrier offset estimate from carrier recovery loop 685 to produce a passband error term, e_{pb}(n), as well as a baseband error term, e(n). Feedback filter 620 operates on baseband data, and thus is adapted with the baseband error terms described for operation of equalizer 200 in FIG. 2. However, since forward filter 610 in FIG. 6 processes passband data, it is adapted by passband error terms that are generated by rotating the baseband error term with the current offset of the carrier recovery estimate, e^{jθ(n)}. For example, let e(n)=e_{I}(n)+je_{Q}(n) be the baseband error term generated in accordance with the methods described for equalizer 200 in FIG. 2, decomposed into in-phase and quadrature-phase components. Then the passband error term used to adapt forward filter 610 in FIG. 6 is calculated according to e_{pb}(n)=e(n)·e^{jθ(n)}, which is decomposed as

e_{pb}(n)=(e_{I}(n)·cos[θ(n)]−e_{Q}(n)·sin[θ(n)])+j(e_{Q}·cos[θ(n)]+e_{I}·sin[θ(n)]).

Combining weights λ(n) and 1−λ(n), and automatic gain control signals α(n) and α⁻¹(n), are calculated in equalizer control module 630 identically to that discussed for equalizer 200 in FIG. 2. Combining weights λ(n) and 1−λ(n) weight two passband error terms to update forward filter 610, and weight two baseband error terms to update feedback filter 620.

One skilled in the art would understand that the equations described herein may include scaling, change of sign, or similar constant modifications that are not shown for simplicity. One skilled in the art would also realize that such modifications can be readily determined or derived for the particular implementation. Thus, the described equations may be subject to such modifications, and are not limited to the exact forms presented herein.

The present invention has been described using Quadrature Amplitude Modulation (QAM) signals with complex signal processing, unless specifically noted. However, one skilled in the art would realize that the techniques described herein may be applied to a receiver processing Phase-Shift Keyed (PSK), Pulse Amplitude Modulation (PAM), Eight Level Vestigial Sideband (8-VSB), Advanced Television Standard Committee (ATSC) or other types of signals.

As would be apparent to one skilled in the art, the various functions of equalization, signal combining, and automatic gain control may be implemented with circuit elements or may also be implemented in the digital domain as processing steps in a software program. Such software may be employed in, for example, a digital signal processor, micro-controller, or general-purpose computer.

The present invention can be embodied in the form of methods and apparatuses for practicing those methods. The present invention can also be embodied in the form of program code embodied in tangible media, such as floppy diskettes, CD-ROMs, hard drives, or any other machine-readable storage medium, wherein, when the program code is loaded into and executed by a machine, such as a computer, the machine becomes an apparatus for practicing the invention. The present invention can also be embodied in the form of program code, for example, whether stored in a storage medium, loaded into and/or executed by a machine, or transmitted over some transmission medium, such as over electrical wiring or cabling, through fiber optics, or via electromagnetic radiation, wherein, when the program code is loaded into and executed by a machine, such as a computer, the machine becomes an apparatus for practicing the invention. When implemented on a general-purpose processor, the program code segments combine with the processor to provide a unique device that operates analogously to specific logic circuits.

Various changes, modifications, additions, deletions in various disclosed embodiments of the present invention including in the details, materials, and arrangements of the various embodiments which have been described and illustrated in order to explain the nature of this invention may be made by those skilled in the art without departing from the principle and scope of the invention as expressed in the following claims.

What is claimed is:

1. In a communications receiver having a decision feedback equalizer filter, said communications receiver responsive to a received signal to form soft decision samples corresponding to said received signal and hard decision samples corresponding to said received signal, a method for operating said decision feedback equalization filter, said method comprising:
linearly combining said soft decision samples and said hard decision samples to form a composite decision sample; and
operating said decision feedback equalization filter by coupling said composite decision samples to said decision feedback equalization filter.

2. A method according to claim 1 further comprising weighting said decision samples prior to combining said decision samples, said weighting including adaptive techniques.

3. A method according to claim 2 wherein said weighting is at least partially based on proximity of soft decisions to hard decisions.

4. A method according to claim 2 wherein said weighting is at least partially based on estimation of signal to noise ratio corresponding to said received signal.

5. A method according to claim 2 wherein said weighting is at least partially based on cluster variance calculation.

6. A method according to claim 2 wherein said weighting is at least partially based on number of symbols processed.

7. A method according to claim 1 wherein filter coefficients for said filter are updated using a constant modulus algorithm error term.

8. A method according to claim 1 wherein filter coefficients for said filter are updated using a least mean squares algorithm error term.

9. A method according to claim 1 wherein filter coefficients for said filter are updated using linear combinations of blind error terms and least mean squares algorithm error terms.

10. A method according to claim 9 wherein said blind error terms include constant modulus algorithm error terms.

11. A method according to claim 9 further comprising weighting said decision samples prior to combining said decision samples, said weighting including adaptive techniques.

12. A method according to claim 11 wherein said weighting is at least partially based on proximity of soft decisions to hard decisions.

13. A method according to claim 11 wherein said weighting is at least partially based on estimation of signal to noise ratio corresponding to said received signal.

14. A method according to claim 11 wherein said weighting is at least partially based on cluster variance calculation.

15. A method according to claim 11 wherein said weighting is at least partially based on number of symbols processed.

16. A method according to claim 1 further comprising applying gain and inverse gain values to signals corresponding to said decision samples using automatic gain control.

17. A method according to claim 16 wherein said automatic gain control minimizes a predetermined cost function using stochastic gradient descent techniques.

18. A method according to claim 17 wherein said cost function includes an algorithm that includes mean squared error-like techniques.

19. A method according to claim 17 wherein said cost function includes an algorithm that includes constant modulus-like techniques.

20. A method according to claim 17 further comprising linearly combining gain values from multiple cost functions, and wherein said gain values are weighted using adaptive techniques.

21. A method according to claim 16 wherein said gain and inverse gain values are strictly positive real values.

22. A method according to claim 1 further comprising applying an error term to a feedforward filter, and filtering a complex data signal corresponding to said received signal using said feedforward filter, wherein said feedforward and said decision feedback equalizer filters operate at precise baseband.

23. A method according to claim 1 further comprising applying an error term to a feedforward filter, and filtering a complex data signal corresponding to said received signal using said feedforward filter, wherein said feedforward filter operates in passband and said decision feedback equalizer filter operates at precise baseband.

24. A method according to claim 1 further comprising applying an error term to a feedforward filter, and filtering a complex data signal corresponding to said received signal using said feedforward filter, wherein said feedforward and said decision feedback equalizer filters operate in passband.

25. A method according to claim 1 wherein said equalizer processes symbols which have been modulated with a quadrature amplitude modulation format.

26. A method according to claim 1 wherein said equalizer processes symbols which have been modulated with a vestigal sideband format in accordance with an Advanced Television Systems Committee standard.

27. In a communications receiver having a decision feedback equalizer, said communications receiver responsive to a received signal, said equalizer adapted to form hard decision samples corresponding to said received signal using a slicer, and to form soft decision samples corresponding to said received signal, a method for operating said decision feedback equalization filter, said method comprising:
generating, using an automatic gain control circuit, gain values and inverse gain values, applying said gain values to decision samples before processing in said slicer, and applying said inverse gain values to decision samples after processing in said slicer;
linearly combining said soft decision samples and said hard decision samples to form a composite decision sample; and
operating a feedback filter in said decision feedback equalization by coupling said composite decision samples to said feedback filter in said equalizer.

28. A method according to claim 27 further comprising generating said gain values using minimization of a predetermined cost function using stochastic gradient descent techniques.

29. A method according to claim 28 wherein said cost function is a mean squared error-like cost function.

30. A method according to claim 28 wherein said cost function is a constant modulus-like cost function.

31. A method according to claim 27 further comprising generating said gain values using minimization of at least two predetermined cost functions, which functions use stochastic gradient descent techniques.

32. A method according to claim 27 further comprising generating said gain values using at least two predetermined cost functions, and linearly combining the gain values, wherein said gain values are weighted using adaptive techniques.

33. A method according to claim 32 further comprising weighting based on proximity of said soft decisions to said hard decisions.

34. A method according to claim 32 further comprising weighting based on estimation of signal to noise ratio corresponding to a signal received by said receiver.

35. A method according to claim 32 further comprising weighting based on cluster variance calculation.

36. A method according to claim 32 further comprising weighting based on number of symbols processed.

37. A method according to claim 27 wherein said gain and said inverse gain are strictly positive real.

38. A method according to claim 27 wherein said equalizer includes a feedforward filter and a feedback filter, and said method includes coupling to each of said filters an error term.

39. A method according to claim 27 wherein said equalizer includes a feedforward filter and a feedback filter, and said method includes coupling to the feedback filter an error term which is different from an error term coupled to the feedforward filter.
